(19) United States
(12) Patent Application Publication
(10) Pub. No.: US 2023/0259350 A1
(43) Pub. Date: Aug. 17, 2023

(54) UPDATING SOFTWARE ON A CONDITIONAL ACCESS MODULE

(71) Applicant: Vestel Elektronik Sanayi ve Ticaret A.S., Manisa (TR)

(72) Inventors: Zeynep Hilal CETINAY, Manisa (TR); Hakan ETIK, Manisa (TR)

(21) Appl. No.: 18/018,013

(22) PCT Filed: Jul. 27, 2020
(86) PCT No.: PCT/EP2020/071125

§ 371 Date: Jan. 25, 2023

(51) Int. Cl. G06F 8/65

(52) U.S. Cl. CPC G06F 8/65

(57) ABSTRACT

A conditional access module, CAM, (20) is in communication with a host device (10). The host device (10) obtains a copy of software which is to be updated on the CAM (20), the copy of software which is to be updated not being received as a broadcast over-the-air signal at the host device or the CAM. The host device (10) sends the copy of the software to the CAM (20). The CAM (20) saves the copy of the software in non-volatile memory of the CAM (20) for use by the CAM (20) when the CAM (20) is operating.

### TECHNICAL FIELD

The present disclosure relates to methods, devices and computer programs for updating software on a conditional access module.

### BACKGROUND

The Digital Video Broadcast Common Interface (DVB-CI) specification describes the interface between a Conditional Access Module (CAM) and the host, which is typically a television set or a set-top box or the like. All the conditional access functionality is provided by the CAM whereas the host provides the necessary tuning functionality and presents audio and video. From time to time, it is necessary to update the software that is running on the CAM. Conventionally, such updates are provided to CAMs in the field (i.e. in use by end users) as broadcast “over-the-air” signals. However, this may not always be successful or convenient.

### SUMMARY

According to a first aspect disclosed herein, there is provided a method of updating software on a conditional access module, CAM, which is in communication with a host device, the method comprising:
the host device obtaining a copy of software which is to be updated on the CAM, the copy of software which is to be updated not being received as a broadcast over-the-air signal at the host device or the CAM;
the host device sending the copy of the software to the CAM; and
the CAM saving the copy of the software in non-volatile memory of the CAM for use by the CAM when the CAM is operating.

The term “software” as used herein in general includes firmware as well as “conventional” software, unless the context requires otherwise. “Firmware” is a specific class of computer software that for example provides low-level control for a device’s specific hardware. Firmware is usually stored in non-volatile memory devices, including for example ROM, EPROM and flash memory.

The copy of the software is not received by the host device as a broadcast “over-the-air” signal. Rather, the copy of the software is received by the host device on demand by the host and/or via a physical connection to a device on which the copy of the updated software has been saved. Further, in examples it is the host device that identifies whether a software update is available for the CAM. This is in contrast with the conventional arrangement in which the CAM receives a trigger which is broadcast and which informs the CAM that a software update is available for the CAM.

The copy of software obtained by the host device, and subsequently transferred to the CAM, may be in the form of an ISO (International Organization for Standardization) image or the like for the CAM.

In an example, the host is a digital television, DTV, receiver.

A DTV receiver typically contains some form of tuner, a demodulator, a demultiplexer and media decoders. The DTV receiver may be for example a digital television set or a set-top box.

A CAM is typically an electronic device that equips an integrated digital television set or set-top box or the like with appropriate hardware functionality to view conditional access content that has been encrypted using a conditional access system. A CAM may also be referred to as a “Common Interface conditional access module” or CICAM since it will typically be in accordance with the DVB-CI specification. CAMs are normally used with direct-broadcast satellite (DBS) services and also for digital terrestrial pay TV services.

The CAM may be a device that is separate from the host or may be embedded or incorporated in the host. When embedded in the host, the CAM may be implemented in software and not as a physical device as such.

In an example, the method comprises, prior to the host device obtaining a copy of software which is to be updated on the CAM:
the host communicating with the CAM to determine a current version of the software on the CAM; and
the host checking whether an updated version of the software is available for the CAM and, if so, the host device obtaining a copy of software which is to be updated on the CAM.

In an example, the method comprises, prior to the host device sending the copy of the software to the CAM:
the host informing the CAM of the size of the updated version of the software;
the CAM checking whether the software can be updated on the CAM based on at least the size of the updated version of the software; and
if the software can be updated on the CAM, the CAM requesting the host device to send the copy of the software to the CAM.

The host may also inform the CAM of other information related to the updated version of the software, which the CAM may also use to check whether the software can be updated on the CAM.

In an example, the host device and the CAM are Common Interface equipment which comply with the EN 50221-1997 standard.

In an example, the host device and the CAM communicate with each other for the update process using messages according to the Specific Application Support of the CI Plus Specification.

The CI Plus Specification may be for example the CI Plus Specification v1.3 or higher.

In an example, the method comprises the host device obtaining a copy of software which is to be updated on the CAM from a physical device which is directly connected to the host device, from another device which is connected to the host device via a wired network connection, or an over-the-air download.

Such a physical device may be for example a flash memory device, which may be connected via for example a USB or other interface. Such a wired network connection may be for a local area network, such as Ethernet. An over-the-air download is not a broadcast signal, and, on the contrary, is typically carried out on demand.

According to a second aspect disclosed herein, there is provided a host device and a conditional access module, CAM, which is in communication with a host device, the host device and CAM being constructed and arranged to update software on the CAM by:
the host device obtaining a copy of software which is to be updated on the CAM, the copy of software which is to be updated not being received as a broadcast over-the-air signal at the host device or the CAM;
the host device sending the copy of the software to the CAM; and
the CAM saving the copy of the software in non-volatile memory of the CAM for use by the CAM when the CAM is operating.

According to a third aspect disclosed herein, there is provided a computer program for updating software on a conditional access module, CAM, which is in communication with a host device, the computer program comprising instructions such that:
the host device obtains a copy of software which is to be updated on the CAM, the copy of software which is to be updated not being received as a broadcast over-the-air signal at the host device or the CAM;
the host device sends the copy of the software to the CAM; and
the CAM saves the copy of the software in non-volatile memory of the CAM for use by the CAM when the CAM is operating.

There may be provided one or more non-transitory computer-readable storage media storing a computer program as described above.

### BRIEF DESCRIPTION OF THE DRAWINGS

To assist understanding of the present disclosure and to show how embodiments may be put into effect, reference is made by way of example to the accompanying drawings in which:

FIG. 1 shows schematically an example of a television signal receiver;

FIG. 2 shows schematically an example of a method according to the present disclosure;

FIG. 3 shows the Specific Application Support (SAS) protocol as defined in CI Plus Specification;

FIG. 4 shows examples of messages that pass between the television signal receiver and the CAM according to the present disclosure; and

FIG. 5 shows schematically a detailed example of a method according to the present disclosure.

### DETAILED DESCRIPTION

As mentioned, the Digital Video Broadcast Common Interface (DVB-CI) specification describes the interface between a Conditional Access Module (CAM) and the host, which is typically a television set or a set-top box or the like. The Common Interface is set out in the EN 50221-1997 standard. The Common Interface is a technology that allows decryption of pay TV channels. In general, pay TV stations want to make their own choice as to which encryption method to use for transmission of TV channels. The Common Interface allows television set and set-top box manufacturers to support many different pay TV stations, by allowing exchangeable conditional-access modules (CAM) for various encryption schemes to be plugged in. The Common Interface provides the connection between the TV tuner (in the television set or set-top box) and the CAM which decrypts the TV signal. The CAM in turn accepts the user’s pay-to-view subscriber card, which contains the access keys and permissions for the user to access the pay-to-view channels. Simply put, the television set or set-top box is responsible for tuning to pay TV channels and demodulation of the received signals while the CAM is responsible for conditional access descrambling.

The Common Interface is commonly provided in television signal receivers. In Europe for example, DVB-CI is obligatory in all iDTV (integrated Digital Television) television sets. The Common Interface uses the PCMCIA connector and conforms to the Common Scrambling Algorithm (CSA), the normative that specifies that such a television signal receiver must be able to accept DES (Data Encryption Standard) keys in intervals of some milliseconds and use them to decode private channels according to a specific algorithm.

The Common Interface may for example be in accordance with the CI Plus Specification. A conditional access module that is compliant with the CI Plus Specification is generally known as a CICAM. Nevertheless, as used herein, the term “CAM” shall be used to include CAMs in accordance with the original CI specification and CICAMs in accordance with the CI Plus Specification, unless the context requires otherwise. The CI Plus Specification provides additional security and other new features compared to the original CI specification. For example, according to the CI Plus Specification, a trusted channel is formed between the CICAM and television receiver, so that the decrypted content can be re-encrypted, using a key that is known at both ends of the trusted channel, before it is sent back from the CICAM to the receiver. The current CI Plus Specification at the present time is v1.4.3.

CAMs have historically used smart cards which contain the access keys and permissions of pay TV operator subscribers. More recently, cardless solutions have been used as this has been shown to be secure enough to protect both the content and the software on the CAM itself. Further, CAMs have historically been provided as discrete devices which are separate from and in communication with the TV receiver. However, more recently, cardless CAMs have been embedded in the TV receiver, which saves end users having to purchase a separate external module and having to locate the separate module somewhere near the TV receiver.

As mentioned, from time to time it is necessary to update the software that is running on the CAM. Such software effectively provides the operating system for the CAM and the specific functionality required of the CAM. Conventionally, such updates are provided to CAMs in the field (i.e. in use by end users) as broadcast “over-the-air” signals. However, this may not always be successful or convenient. For example, such updates are typically only broadcast for a limited time so as to minimise the use of bandwidth that is available to the broadcasters, meaning that it could be missed by the CAM.

In examples of the present disclosure, the host device (which in examples in practice is typically a television set or a set-top box or the like) obtains a copy of software which is to be updated on the CAM. The host device sends the copy of the software to the CAM. The CAM then saves the copy of the software in non-volatile memory of the CAM for use by the CAM when the CAM is operating.

The host device can obtain a copy of software which is to be updated on the CAM in general from any source. For example, the copy of the software may be obtained by the host device from a USB flash memory device which is physically connected to the host device when an update is to be carried out; or from another device which is connected to the host device via a wired network connection, which may for example be a wired network connection for a local area network such as an Ethernet connection; as an over-the-air download; etc. Notably, the software which is to be updated is not provided to the host device or the CAM as a broadcast, over-the-air signal.

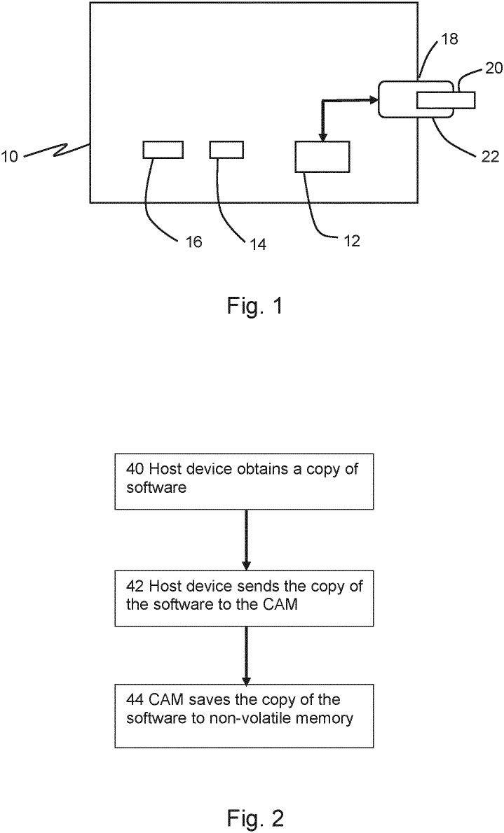

Referring now to FIG. 1, this shows schematically an example of a host device to which is connected a Conditional Access Module (CAM) 20. In this example, the host device 10 is a television signal receiver 10. In the example shown, the television signal receiver 10 is or is incorporated in a television set which has an integral TV signal receiver or tuner. In other examples, the television signal receiver 10 may be or may be incorporated in a set-top box or the like which has a TV signal receiver or tuner and which is connected in use to a television set or other display device. The television signal receiver 10 has a processor 12, working memory 14 and data storage 16 as commonly provided in television signal receivers.

The television signal receiver 10 also has a connection or port 18 to which the CAM 20 can be connected for communication with the television signal receiver 10. The port 18 is a PCMCIA (Personal Computer Memory Card International Association) connector 18 as required by the DVB-CI specification, though in principle other standards for the port 18 may be used. The CAM 20 may require a smart card, which contain the access keys and permissions of pay TV operator subscribers, or may be of the cardless type that does not require a physical smart card. Further, whilst shown as a separate device in FIG. 1, the CAM 20 (whether of the carded or cardless type) may instead be embedded in the television signal receiver 10, and may be implemented entirely in software or partly in software and partly in hardware. The television signal receiver 10 and the CAM 20 communicate with each other in accordance with the Common Interface which is set out in the EN 50221-1997 standard.

Conventionally, when updated software for a CAM is available, then, in accordance with the current CI Plus Specification v1.3, a trigger for the update is broadcast in a broadcast signal. On receipt of the broadcast trigger, the CAM informs the television signal receiver of the availability of the updated software. The television signal receiver then tunes to an appropriate broadcast channel in order to obtain the updated software which is passed to the CAM. The CAM then updates itself with the new software.

In contrast, in accordance with the present disclosure and referring to FIG. 2, at 40 the host device 10, which in this example is a television signal receiver 10, obtains a copy of software which is to be updated on the CAM 20. At 42, the host device 10 sends the copy of the software to the CAM 20. At 44, the CAM 20 saves the copy of the software in non-volatile memory of the CAM 20 for use by the CAM 20 when the CAM 20 is operating. The copy of the software is not received by the host device 10 as a broadcast “over-the-air” signal. Rather, as will be discussed further below, the copy of the software is received by the host device on demand by the host and/or via a physical connection to a device on which the copy of the updated software has been saved. Further, in examples it is the host device 10 that identifies whether a software update is available for the CAM 20. This is in contrast with the conventional arrangement in which the CAM receives a trigger which is broadcast and which informs the CAM that a software update is available for the CAM, as discussed above. (It may be noted that the conventional arrangement may still be used for software updates, with the broadcast trigger being received at and processed by the television signal receiver as conventional. Embodiments of the present disclosure may be used for updates that have for example been missed by the television signal receiver and/or for other updates, for example updates that are not broadcast.)

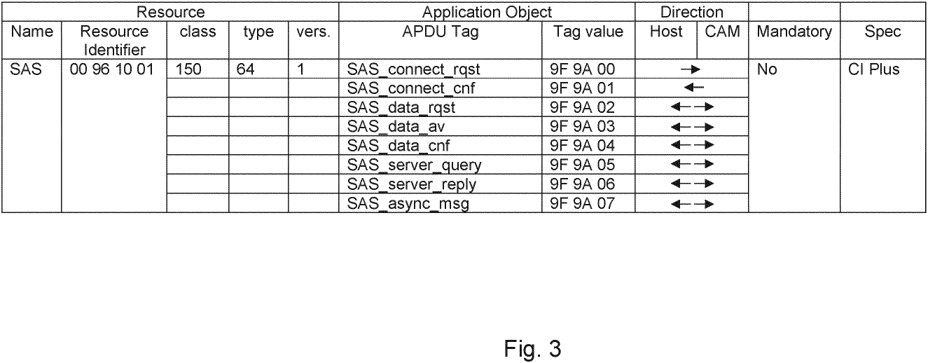

During this process, the television signal receiver 10 and the CAM 20 need to communicate with each other, to send messages concerning the update procedure. In this regard, it is noted that the CI Plus Specification provides a Specific Application Support (SAS) resource, which allows an application on the television signal receiver 10 to access functionality on the CAM 20. The SAS is used herein in examples as the basis for a command set which is implemented on the television signal receiver 10 and the CAM 20 to allow the present software update process for the CAM 20 to be carried out. In particular, messages between the television signal receiver 10 and the CAM 20 have a format that is in accordance with the SAS of the CI Plus Specification. The SAS protocol is defined in the CI Plus Specification as shown in FIG. 3.

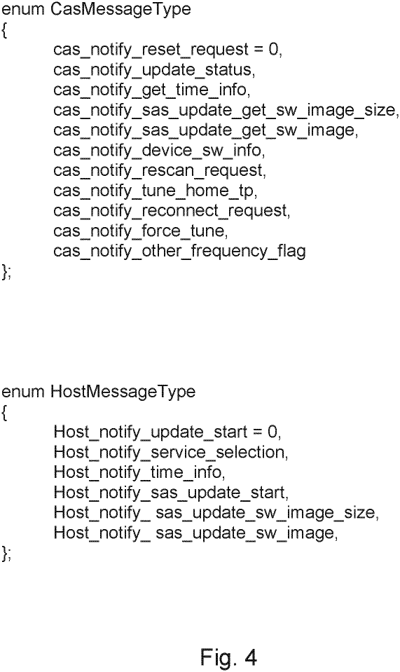

Examples of the present disclosure use tag messages that are specific to the present software update process for the CAM 20 and that are based on the SAS messaging mechanism provided in accordance with the CI Plus Specification. Examples of the tag messages are shown in FIG. 4 and will be discussed further below.

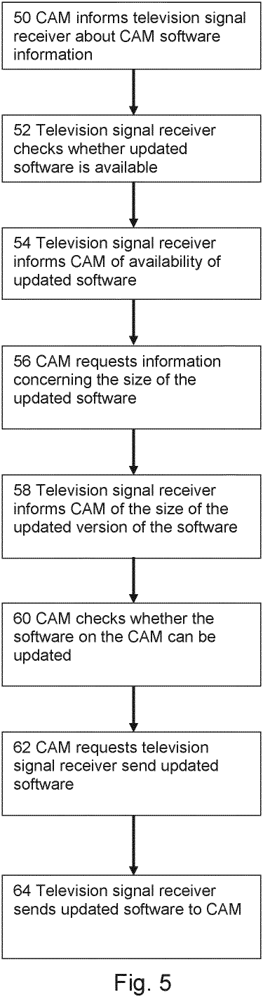

In a detailed example and referring now to FIG. 5, at 50 the CAM 20 provides information concerning the current version of the software on the CAM 20 to the television signal receiver 10. This may take place for example as part of device initialisation, when the television signal receiver 10 is powered up from an off or stand-by state. In an example, this is carried out using a custom SAS cas_notify_device_sw_info message tag, shown in FIG. 4.

At 52, the television signal receiver 10 then checks whether updated software that is intended or suitable for the CAM 20 is available. This checking by the television signal receiver 10 for updated software may be carried out automatically. For example, this may be carried out by the television signal receiver 10 automatically in response to the television signal receiver 10 receiving from the CAM 20 the information concerning the current version of the software on the CAM 20. Alternatively or additionally, the user may be offered the option by the television signal receiver 10 to allow the automatic update process to proceed or not. Alternatively or additionally, the user may be offered the option by the television signal receiver 10 to force the update manually.

The television signal receiver 10 can check for, and obtain a copy of, software which is to be updated on the CAM 20 in general from any source. For example, the copy of the software may be obtained by the television signal receiver 10 from a USB flash memory device which is physically connected by a user or some service technician or the like to the television signal receiver 10 when an update is to be carried out. Alternatively or additionally, the copy of the software may be obtained by the television signal receiver 10 from another device which is connected to the host device via a wired network connection, such as an Ethernet connection. Alternatively or additionally, the copy of the software may be obtained by the television signal receiver 10 as an over-the-air download. Other options may be available. If updated software is available, the television signal receiver 10 obtains a copy of the software and stores it in memory, which may be volatile memory such as RAM. The copy of the software may be obtained in the form of an ISO (International Organization for Standardization) image or the like.

If the television signal receiver 10 does find an updated version of software for the CAM 20, then at 54 the television signal receiver 10 informs the CAM 20 accordingly. In an example, this is carried out using a custom SAS host_notify_sas_update_start message tag, shown in FIG. 4.

Then, at 56, the CAM 20 requests from the television signal receiver 10 information concerning the size of the updated software. The CAM 20 may also optionally request other information related to the updated version of the software from the television signal receiver 10. Such other information may be required for example in order to differentiate between update images for different brands and/or different models of the television signal receiver. In an example, this is carried out using a custom SAS cas_notify_sas_update_get_sw_image_size message tag, shown in FIG. 4.

At 58, the television signal receiver 10 informs the CAM 20 of the size of the updated version of the software. The television signal receiver 10 may also pass other information related to the updated version of the software to the CAM 20 if requested and the information is available. In an example, this is carried out using a custom SAS host_notify_sas_update_sw_image_size message tag, shown in FIG. 4.

At 60, the CAM 20 checks whether the software can be updated on the CAM 20 based on at least the size of the updated version of the software. The CAM 20 may also check whether the software can be updated on the CAM 20 based on the other information related to the updated version of the software if provided by the television signal receiver 10 to the CAM 20.

If the CAM 20 determines that, at least as far as the CAM 20 is concerned, everything is in order for the CAM 20 to update the software, then at 62 the CAM 20 requests that the television signal receiver 10 sends the updated software to the CAM 20. In an example, this is carried out using a custom SAS cas_notify_sas_update_get_sw_imagemessage tag, shown in FIG. 4.

At 64, the television signal receiver 10 sends the updated software to the CAM 20. In an example, this is carried out using a custom SAS host_notify_sas_update_sw_image message tag, shown in FIG. 4. As part of this, the television signal receiver 10 may divide the software image file into partitions and send the partitions in turn to the CAM 20 as there is a size limit on messages that can be sent using SAS. On receiving the updated software from the television signal receiver 10, the CAM 20 can then save the updated software to non-volatile memory for use by the CAM 20 when the CAM 20 is operating.

The CAM 20 is arranged to inform the television signal receiver 10 about the status of the software update throughout this process so that the television signal receiver 10 can take any necessary actions. For example, if a part of the software has not been correctly received by the CAM 20, the television signal receiver 10 can send that part to the CAM 20 again.

Examples described herein enable software on a CAM to be updated without requiring that updated software to be transmitted as a broadcast signal. The updated software for the CAM can be obtained “on demand”, for example as part of an automated process or when manually instigated by a user.

It will be understood that the processor or processing system or circuitry referred to herein may in practice be provided by a single chip or integrated circuit or plural chips or integrated circuits, optionally provided as a chipset, an application-specific integrated circuit (ASIC), field-programmable gate array (FPGA), digital signal processor (DSP), graphics processing units (GPUs), etc. The chip or chips may comprise circuitry (as well as possibly firmware) for embodying at least one or more of a data processor or processors, a digital signal processor or processors, baseband circuitry and radio frequency circuitry, which are configurable so as to operate in accordance with the exemplary embodiments. In this regard, the exemplary embodiments may be implemented at least in part by computer software stored in (non-transitory) memory and executable by the processor, or by hardware, or by a combination of tangibly stored software and hardware (and tangibly stored firmware).

Reference is made herein to data storage for storing data. This may be provided by a single device or by plural devices. Suitable devices include for example a hard disk and non-volatile semiconductor memory (including for example a solid-state drive or SSD).

Although at least some aspects of the embodiments described herein with reference to the drawings comprise computer processes performed in processing systems or processors, the invention also extends to computer programs, particularly computer programs on or in a carrier, adapted for putting the invention into practice. The program may be in the form of non-transitory source code, object code, a code intermediate source and object code such as in partially compiled form, or in any other non-transitory form suitable for use in the implementation of processes according to the invention. The carrier may be any entity or device capable of carrying the program. For example, the carrier may comprise a storage medium, such as a solid-state drive (SSD) or other semiconductor-based RAM; a ROM, for example a CD ROM or a semiconductor ROM; a magnetic recording medium, for example a floppy disk or hard disk; optical memory devices in general; etc.

The examples described herein are to be understood as illustrative examples of embodiments of the invention. Further embodiments and examples are envisaged. Any feature described in relation to any one example or embodiment may be used alone or in combination with other features. In addition, any feature described in relation to any one example or embodiment may also be used in combination with one or more features of any other of the examples or embodiments, or any combination of any other of the examples or embodiments. Furthermore, equivalents and modifications not described herein may also be employed within the scope of the invention, which is defined in the claims.

1. A method of updating software on a conditional access module, CAM, which is in communication with a host device, the method comprising:
the host device obtaining a copy of software which is to be updated on the CAM, the copy of software which is to be updated not being received as a broadcast over-the-air signal at the host device or the CAM;
the host device sending the copy of the software to the CAM; and
the CAM saving the copy of the software in non-volatile memory of the CAM for use by the CAM when the CAM is operating.

2. A method according to claim 1, wherein the host is a digital television, DTV, receiver.

3. A method according to claim 1, comprising, prior to the host device obtaining a copy of software which is to be updated on the CAM:
the host communicating with the CAM to determine a current version of the software on the CAM; and
the host checking whether an updated version of the software is available for the CAM and, if so, the host device obtaining a copy of software which is to be updated on the CAM.

4. A method according to claim 1, comprising, prior to the host device sending the copy of the software to the CAM:
the host informing the CAM of the size of the updated version of the software;
the CAM checking whether the software can be updated on the CAM based on at least the size of the updated version of the software; and
if the software can be updated on the CAM, the CAM requesting the host device to send the copy of the software to the CAM.

5. A method according to claim 1, wherein the host device and the CAM are Common Interface equipment which comply with the EN 50221-1997 standard.

6. A method according to claim 5, wherein the host device and the CAM communicate with each other for the update process using messages according to the Specific Application Support of the CI Plus Specification.

7. A method according to claim 1, the host device obtaining a copy of software which is to be updated on the CAM from a physical device which is directly connected to the host device, from another device which is connected to the host device via a wired network connection, or an over-the-air download.

8. A host device and a conditional access module, CAM, which is in communication with a host device, the host device and CAM being constructed and arranged to update software on the CAM by:
the host device obtaining a copy of software which is to be updated on the CAM, the copy of software which is to be updated not being received as a broadcast over-the-air signal at the host device or the CAM;
the host device sending the copy of the software to the CAM; and
the CAM saving the copy of the software in non-volatile memory of the CAM for use by the CAM when the CAM is operating.

9. A host device and a CAM according to claim 8, wherein the host is a digital television, DTV, receiver.

10. A host device and a CAM according to claim 8, constructed and arranged such that prior to the host device obtaining a copy of software which is to be updated on the CAM:
the host communicates with the CAM to determine a current version of the software on the CAM; and
the host checks whether an updated version of the software is available for the CAM and, if so, the host device obtains a copy of software which is to be updated on the CAM.

11. A host device and a CAM according to claim 8, constructed and arranged such that prior to the host device sending the copy of the software to the CAM:
the host informs the CAM of the size of the updated version of the software;
the CAM checks whether the software can be updated on the CAM based on at least the size of the updated version of the software; and
if the software can be updated on the CAM, the CAM requests the host device to send the copy of the software to the CAM.

12. A host device and a CAM according to claim 8, wherein the host device and the CAM are Common Interface equipment which comply with the EN 50221-1997 standard.

13. A host device and a CAM according to claim 12, wherein the host device and the CAM are arranged to communicate with each other for the update process using messages according to the Specific Application Support of the CI Plus Specification.

14. A host device and a CAM according to claim 8, wherein the host device is arranged to obtain a copy of software which is to be updated on the CAM by one or more of: from a physical device which is directly connected to the host device in use, from another device which is connected to the host device via a wired network connection in use, or an over-the-air download.

15. A computer program for updating software on a conditional access module, CAM, which is in communication with a host device, the computer program comprising instructions such that:
the host device obtains a copy of software which is to be updated on the CAM, the copy of software which is to be updated not being received as a broadcast over-the-air signal at the host device or the CAM;
the host device sends the copy of the software to the CAM; and
the CAM saves the copy of the software in non-volatile memory of the CAM for use by the CAM when the CAM is operating.
